(19) United States
(12) Patent Application Publication
(10) Pub. No.: US 2009/0119171 A1
(43) Pub. Date: May 7, 2009

(54) NETWORKS, METHODS, AND SYSTEMS FOR ENCOURAGING TIMELY FULFILLMENT OF PERIODIC OBLIGATIONS

(76) Inventors: Darrell E. Goff, Highland, UT (US); Tom R. Hammond, Highland, UT (US); Kyle Widdison, Saratoga, UT (US)

Correspondence Address: TRASKBRITT, P.C., P.O. BOX 2550, SALT LAKE CITY, UT, 84110, US

(21) Appl. No.: 12/260,756

(22) Filed: Oct. 29, 2008

Related U.S. Application Data
(60) Provisional application No. 60/983,534, filed on Oct. 29, 2007.

(51) Int. Cl. G06Q 30/00; G06Q 20/00

(52) U.S. Cl. 705/14; 705/40

(57) ABSTRACT

The present invention includes networks, methods, and systems for encouraging the timely payment of bills and, more specifically, to networks, methods and systems by which rewards are granted to promote the timely payment of bills.

### CROSS-REFERENCE TO RELATED APPLICATION

This application claims the benefit of priority under 35 U.S.C. § 119(e)(1) to U.S. Provisional Application Ser. No. 60/983,534, filed Oct. 29, 2007, the disclosure of which is hereby incorporated herein, in its entirety, by this reference.

### FIELD OF INVENTION

The present invention relates generally to networks, methods, and systems for encouraging the timely payment of bills and, more specifically, to networks, methods and systems by which rewards are granted to promote the timely payment of bills.

### SUMMARY

A network that incorporates teachings of the present invention includes at least three different parties: a payment receiver, or vendor; a group of bill payers, or consumers, obligated to remit payment to the vendor; and at least one reward partner. In some embodiments, a network according to the present invention may also include an administrator. The vendor is a party to which a regular (e.g., monthly, quarterly, annual, etc.) payment, or bill, is due. The consumer is the party who is responsible for making the payment. The reward partner is a third party that directly or indirectly grants rewards to a consumer when that consumer's bills to the vendor are paid on time and in full. The rewards may include incentives (e.g., discounts, rebates, credits, products, etc.) that are intended to increase the consumer's exposure to the reward partner's business. The vendor uses the rewards as incentive to encourage consumers to pay their bills on time.

Additionally, in some embodiments, a network according to the present invention may include a fourth party administrator. The administrator may establish relationships between vendors and one or more reward partners. The administrator may also administer and manage the relationship between the vendor, each reward partner, and the consumers. In administering and/or managing the relationship between the other parties to a network of the present invention, an administrator may keep an accounting of any rewards that are accrued by and/or used by each participating consumer. In addition, the administrator may perform other tasks relating to the network, such as receiving payments from the consumers on behalf of the vendor and granting rewards to customers on behalf of a reward partner or vendor. The administrator may also monitor consumers' buying habits, provide that information to reward partners or other parties (e.g., potential vendors, potential reward partners, etc.) that may benefit from such information, and perform other tasks that relate to the development and maintenance of a network that incorporates teachings of the present invention.

One or more reward partners may directly or indirectly grant one or more rewards to each consumer in the network when that consumer's payment obligation or obligations are paid on time. The reward partner's potential benefit for providing rewards includes increased exposure the reward partner's business by enticing existing and potential customers, such as consumers that receive the rewards, to exploit the rewards and obtain goods or services from the reward partner.

The availability of rewards for timely payment, especially when advertised, may attract additional business to the vendor. In addition, by conditionally granting rewards, the vendor incentivizes its customers, the consumers, to meet the conditions (e.g., timely payment of bills) necessary for receipt of the rewards. Since rewards are provided by a third party reward partner, the payment receiver incurs little or no expense in granting the rewards. In fact, as the number of consumers that pay their bills on time increases, the vendor's expenses associated with the collection of late payments decrease. As a result, the vendor may actually save money by participating in a network according to the present invention.

Consumers receive rewards when their bills are paid on time. The rewards that are received may provide the consumers with monetary savings for goods or services the bill payers may have already had an interest in purchasing. When rewards are used to encourage consumers to pay their bills on time, the consumers may also benefit by avoiding additional charges that may have otherwise been incurred by late payment of bills, as well as by an improved credit rating.

When a network of the present invention includes a fourth party administrator, the fourth party administrator may establish the network, including relationships between a vendor and one or more reward partners, monitor or even administer a vendor's accounts receivable, and/or grant rewards. Optionally, the fourth party administrator may monitor, or track, use of the rewards, buying habits of targeted consumers, and the like. Such information may be used to determine the potential desirability of different types of rewards to consumers, payment trends, and/or the use of rewards, as well as the benefits that each reward partner gleans by participating in a network that incorporates teachings of the present invention. The fourth party administrator may include a single party, or a plurality of parties that perform different tasks to establish and administer a network according to the present invention.

Systems of the present invention are configured or, in the case of computer operated systems, programmed to administer one or more features of the network. As an example, a system of the present invention may be configured or programmed to monitor or administer a payment receiver's accounts receivable, to track payment trends, to observe the types of rewards that are chosen by bill payers that pay their bills on time, and/or to monitor use and/or accumulation of rewards that have been granted to bill payers. Additionally, a system of the present invention may evaluate data obtained from monitoring activities to provide reward partners with meaningful information about the effectiveness of their advertising and/or marketing efforts in a network that incorporates teachings of the present invention, or to entice potential vendors and/or reward partners into participating in such a network.

In some embodiments, a system of the present invention includes a billing element and a reward management element. The billing element may be accessed by a vendor or by another party acting on behalf of the vendor. Among other functions, the billing element may administer period billing and the granting of rewards when timely payments are received. The reward management element may be accessed by a consumer, where the consumer may select, monitor, and redeem rewards. Such a system may also include computers by which various elements are accessed by the parties that participate in a network of the present invention to effect other aspects of such a network.

In another aspect, the present invention includes methods for developing networks that promote the timely payment of bills. The networks may be developed by fourth party administrators, or by rewards partners or payment receivers.

Other aspects, features, and advantages of the present invention will become apparent to those of ordinary skill in the art through consideration of the ensuing description, the accompanying drawings, and the appended claims.

### BRIEF DESCRIPTION OF THE DRAWINGS

In the drawings, which illustrate various features of different aspects of the present invention:

FIG. 1 is a schematic diagram of an embodiment of a network according to the present invention; and

FIG. 2 is a schematic diagram of another embodiment of a network that incorporates teachings of the present invention.

### DETAILED DESCRIPTION

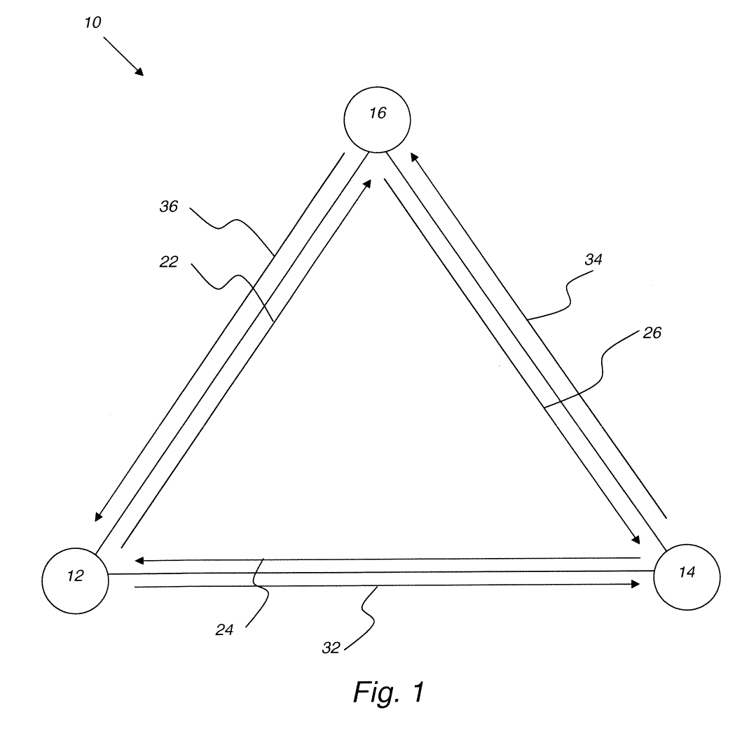

With reference to FIG. 1, a schematic representation of a reward network 10 that incorporates teachings of the present invention is shown. Reward network 10 includes at least three parties: a vendor 12, a plurality of consumers 14, and at least one reward partner 16.

Vendor 12 provides something of value to consumers 14, as represented by arrow 32. As an example, vendor 12 may be a landlord. In other examples, vendor 12 may be a utility company, a lender, a lessor, or the like.

Consumers 14 are parties (e.g., businesses, individuals, etc.) that incur obligations to vendor 12 in return for receiving the something of value provided by vendor 12. The obligation of each consumer 14 to vendor 12 is represented by arrow 24. The obligation may be in the form of the requirement to pay a periodic bill. The periodic bill may comprise a fixed or variable bill that may be due on a regular basis (e.g., weekly, bimonthly, monthly, quarterly, annually, etc.) by a series of predetermined deadlines. Consumers 14 may be tenants, utility consumers, borrowers, lessees, or the like. If consumers 14 fail to meet their periodic obligation of paying vendor 12 on time, they may suffer any number of negative consequences, including, but not limited to, late fees and a reduced credit rating. Additionally, in some instances, such as when consumers 14 receive a service from vendor 12, late-paying consumers 14 may temporarily lose that service. The consequences for non-paying consumers 14 may be even more severe, and include, without limitation, permanent loss of service, eviction, collection, and loss of deposits or collateral. Despite the negative implications for failing to make periodic payments by predetermined deadlines, many consumers 14 continue to pay their bills late or only remit partial payment.

The presence of one or more third parties, the reward partners 16, in network 10 introduces some positive motivation for consumers 14 to make timely and full payments to a vendor 12. A reward partner 16 is a party that is desirous to advertise its business to an identifiable, or known, group of consumers and entice that group of consumers to increase the consumers' exposure to reward partner's 16 business. Through an established relationship with vendor 12 in network 10, reward partner 16 may advertise directly to consumers 14 of vendor 12. Reward partner 16 may attract business, or advertise, in return for making one or more rewards 26, symbolized as an arrow, available to vendor's 12 consumers 14 that meet their periodic obligations (e.g., pay their bills) on time and in full.

A reward 26 may be provided for a single timely and full payment. Alternatively, a reward 26 may be earned for a predetermined number of timely and full payments (e.g., sequential or non-sequential).

A reward 26 may be embodied as a financial incentive for a consumer 14 to increase his, her, or its exposure to reward partner 16. Alternatively, reward 26 may be a non-financial incentive for increasing a consumer's 14 exposure to reward partner 16. Examples of rewards 26 that may be provided by a reward partner 16 include, but are not limited to, coupons, rebates, credits (e.g., gift cards, etc.), products (e.g., a product that is most useful with, or useful only with, another product, such as audio/video components, cellular telephone accessories, a battery for a portable drill, etc.) and a variety of other considerations. In some embodiments, rewards 26 may be provided directly to a consumer 14. In other embodiments, a reward 26 may be provided indirectly from one reward partner 16 to consumer 14; for example, as a credit that may be used when consumer 14 purchases goods or services from another reward partner 16.

In some embodiments, a network 10 of the present invention may include more than one category of reward partners 16. A specific embodiment of such a network 10 includes first-level reward partners 16, who participate in network 10 (i.e., provide rewards) on a regular basis, as well as second-level reward partners 16, who may participate in network 10 on a limited (e.g., irregular, temporary, periodic, etc.) basis. Examples of second-level reward partners 16 include companies that typically do not market by offering discounts, but that may find themselves in an unusual situation where offering discounts may move inventory or otherwise improve business (e.g., a theater that is usually popular, but exhibits an unpopular show; a retail store with an unanticipated overstock of one or more products; a retail store attempting to move seasonal items, etc.).

Rewards 26 may be granted to consumers 14 by reward partner 16, which may increase a reward partner 16's exposure to consumers 14. Alternatively, rewards 26 may be granted to consumers 14 in a way that shields the identities of specific consumers 14 from reward partner 16. For example, vendor 12 may distribute rewards 26 to consumers 14 that have fulfilled their period obligations. As another alternative, as described in further detail hereinafter, another, fourth, party may distribute rewards 26 to consumers 14 upon meeting their periodic obligations, or to vendor 12, who then distributes rewards 26 to consumers 14.

Reward partners 16 may be allowed to periodically (e.g., once every month, once every quarter, once every six months, once each year, etc.) change the reward or rewards that are available to consumers 14.

An example of a reward partner 16 is a local retail store or restaurant, or retailer, that would like to increase the number of people visiting its premises, or “foot traffic.” The type of reward or rewards that are made available by such a business may require consumers 14 who receive the reward or rewards to visit the premises to redeem the reward. By enticing consumers 14 to visit the premises, the probability that consumers 14 will purchase additional products from reward partner 16 increases.

As another example, reward partner 16 may be a business that provides a delivery service (e.g., a restaurant, a courier, etc.). When consumers 14 redeem rewards provided by such a reward partner 16, consumers 14 will be exposed and hopefully grow accustomed to the convenience of the service provided by reward partner 16.

In another example, vendor 12 may rent a residence (e.g., a home, an apartment, etc.), consumer 14 may be an individual tenant, and reward partner 16 may be a home builder. By paying his or her rent on time (e.g., by the due date, not within any grace period thereafter) for a predetermined cumulative number of periods of time (e.g., six months, one year, etc.), consumer 14 may earn a credit toward the purchase of a home. Such a reward may be earned incrementally for each timely fulfillment of a consumer's 14 obligation to vendor 12, up to a maximum amount. Alternatively, a reward may be granted when a consumer's 14 periodic obligations to vendor 12 have been met for a predetermined number of cumulative payment periods, regardless of whether consumer 14 fails to make a timely payment while earning credit toward a reward. As another alternative, a reward may be granted when a consumer's 14 obligations to vendor 12 are fulfilled for a predetermined number of consecutive payment periods, in which case a consumer 14 cannot miss any payments while earning credit toward the reward (e.g., to prove to reward partner 16 that consumer 14 will be a reliable, or low-risk, debtor).

Of course, any other type of party that is interested in attracting customers may also be a reward partner 16.

In operation of network 10, a vendor 12 may, by participating in network 10, advertise to potential consumers 14 that they may receive rewards merely for meeting their obligations on time. Advertisement by vendor 12 to potential consumers 14 is represented by arrow 32.

Each consumer 14 may, upon entering a relationship with vendor 12, or at some point following the establishment of such a relationship, register to participate in network 10 or otherwise opt in to network 10. In some embodiments, a consumer 14 that chooses to participate in network 10 decide to receive rewards from one or more reward partners 16 that participate in that network 10.

Alternatively, a consumer's 14 presence in network 10, merely by virtue of that consumer's 14 entering into a relationship with vendor 12, may automatically qualify that consumer 14 for participation in network 10. When a consumer 14 is automatically enrolled in a network 10, that consumer may immediate begin to accrue rewards 26 from one or more reward partners 16, regardless of whether that consumer 14 has activated his or her account. Upon activating his or her account, that consumer 14 may then redeem his or her rewards 26.

Each consumer 14 within network 10 may preselect one or more reward partners 16 from a predetermined group of reward partners (e.g., those participating in network 10) whose rewards will be made available to that consumer 14 when that consumer 14 fulfills its periodic obligation in a timely manner. Alternatively, a consumer 14 may preselect a predetermined number of (one or more) rewards, from a group of rewards that are available to consumers 14 participating in network 10, that will be granted once that consumer 14 meets a periodic obligation. The number of rewards 26 available to each customer 14 may be limited by number, value, or in some other manner. In some embodiments of network 10, it is possible, although not necessary, that the value of rewards 26 granted to a consumer 14 for meeting a single periodic obligation, if redeemed, may exceed the monetary amount of that obligation. Additionally, consumers 14 may periodically (e.g., once every quarter, once every six months, once each year, etc.) reselect rewards that may be received during the ensuing period of time in the event that the periodic obligations of consumer 14 are met during that ensuing period of time. The frequency with which consumers 14 may reselect potential rewards 26 may coincide with the frequency with which reward partners 16 are allowed to vary the reward or rewards they provide. By allowing consumers 14 to preselect one or more reward partners 16 or rewards 26, consumers 14 are likely to think about the preselected reward partners 16 or rewards 26 each time they remember their periodic obligation to vendor 12, creating an advertising impression that may inherently increase the level of one or more reward partners 16 exposure to consumers 14.

In some embodiments, a network 10 may be configured to prevent unwanted solicitation of consumers 14 in that network 10 by the reward partners 16 who participate in that network 10. In a specific embodiment, each reward partner 16 may only be permitted to provide solicitations (e.g., printed advertisements, e-mails, etc.) to a consumer 14 when that consumer 14 has “opted in,” or affirmatively chosen to receive rewards from that reward partner 16. Each consumer 14 within a network 10 may chose to receive rewards from one or more reward partners 16 in that network 10. A consumer 14's choices may be made in any suitable manner (e.g., in writing, by accessing a consumer 14—dedicated page on a website associated with network 10, etc.).

In return for providing rewards 26 to consumers 14 that meet their periodic obligations, each reward partner 16 may receive business from one or more consumers 14, as symbolized by arrow 34.

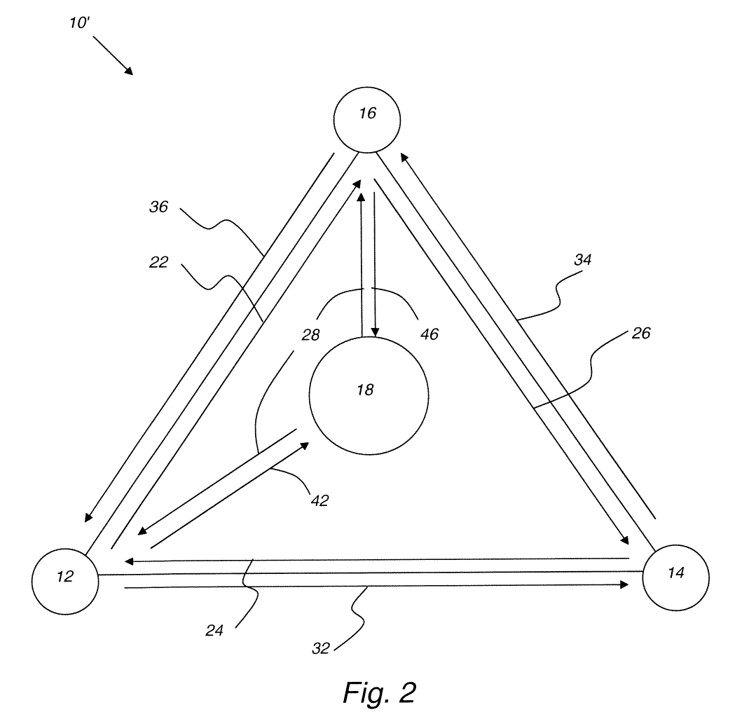

Turning now to FIG. 2, in addition to a vendor 12, consumers 14, and at least one reward partner 16, another embodiment of network 10′ of the present invention may optionally include one or more administrators 18. An administrator 18 may set up network 10′. For example, administrator 18 establishes a relationship between a vendor 12 and one or more reward partners 16, as represented by arrows 28. Reward partner 16 and/or vendor 12 may pay administrator 18 for the opportunity to participate in a network 10′ that incorporates teachings of the present invention, as symbolized by arrows 42 and 46.

In addition to establishing network 10′ and establishing relationships between vendor 12 and one or more reward partners 16, administrator 18 may perform a variety of other tasks. For example, administrator 18 may receive payments on behalf of vendor 12 and/or monitor whether or not consumers 14 have met their obligations to vendor 12. As another example of an administrator 18's responsibilities, once an administrator 18 receives confirmation that a consumer's 14 periodic obligation has been fulfilled, administrator 18 may grant one or more rewards to that consumer 14, a service that may be paid for by a reward partner 16, at arrow 46, whose reward is granted to consumer 14.

Administrator 18 may, in some embodiments, be compensated by vendor 12, as symbolized by arrow 42. When vendor 12 compensates administrator 18, the compensation may comprise a relatively nominal sum (e.g., $0.50 per consumer 14 per month, $1.00 per consumer 14 per month, etc.). If the per-consumer 14 compensation from vendor 12 to administrator 18 is relatively nominal, little or no additional expense will be incurred by each consumer 14 within a network 10′ of the present invention.

In a further example, administrator 18 may track the accumulation of rewards by one or more consumers 14, the redemption of rewards by one or more consumers 14, and/or the buying habits of individual consumers 14 or the collective group of consumers 14 within a particular network 10′. The data that is collected may be used to identify buying trends, additional products or services that may be of interest to a targeted group of consumers, the effectiveness of a particular reward partner's 16 advertising efforts within network 10′, as well as other information that may be useful to others. The information that is obtained from administrator's 18 monitoring efforts may be presented to a reward partner 16, a service for which administrator 18 may receive compensation from reward partner 16 at arrow 46. Alternatively, the information obtain from administrator's 18 monitoring efforts may be provided to parties, such as potential vendors and reward partners, that may be interested in participating in a network according to the present invention.

While an administrator 18 may receive compensation for a variety of services, in various embodiments, reward partners 16 are the primary source of an administrator's compensation.

In some embodiments, a reward partner 16 may compensate an administrator 18 for each consumer 14 that “opts in,” or chooses to receive that reward partner's rewards. Such compensation is agreed upon between administrator 18 and reward partner 16 in advance. Administrator 18 may be compensated on a one-time basis or periodically. In a specific embodiment, a reward partner 16 may pay administrator 18 a predetermined monthly fee (e.g., $0.50, $1.00, etc.) for each consumer 14 that chooses to receive rewards from that reward partner 16.

In other embodiments, a reward partner 16 may compensate an administrator 18 for each consumer 14 within a network 10′ where that reward partner 16's rewards are available. In such embodiments, compensation is not based upon an affirmative choice act by or on the part of any consumer 14; rather, administrator 18 receives a predetermined amount for the number of consumers 14 within network 10′ at a particular point in time. One or more (e.g., each) reward partner 16 within network 10′ may pay administrator 18 a predetermined amount of money (e.g., $0.05, $0.10, $0.25, etc.) at the beginning of a particular period of time (e.g., month) for each consumer 14 who is qualified to participate in network 10′ at the beginning of that particular period of time.

In some embodiments, administrator 18 may receive compensation from a reward partner 16 when a consumer 14 redeems one or more rewards from that reward partner 16. In more specific embodiments, an administrator 18 may receive compensation in the form of a commission, a fixed payment amount for each unit sale, or the like.

As rewards 26 may be provided at little or no cost to vendor 12, rewards 26 may be made available and/or provided to consumers 14 without directly or indirectly increasing the cost to consumer 14 of doing business with vendor 12.

A network 10, 10′ according to the present invention may be administered in accordance with rules that protect each consumer's 14 privacy, prevent unwanted advertisement by reward providers 16 within network or others (e.g., span, junk mail, etc.), impose limitations on the availability of incentives from reward partners 16 that are targeted to consumers 14 outside of the scope of consumers' 14 obligations to vendor 12, as well as a variety of other rules that maintain the primary purpose of network 10, 10′ to encourage consumers 14 to meet their obligations on time without increasing the cost for consumers 14 in meeting those obligations.

With continued reference to FIGS. 1 and 2, a system of the present invention may include one or more computers associated with each participant in network 10, 10′.

A consumer 14 accessible element of the system may enable each consumer 14 to manage his or her account. A consumer account may be activated as a consumer 14 accesses the system (e.g., via a computer through an internet connection, etc.), searches for the appropriate vendor 12, and selects one or more reward partners 16. In some embodiments, a consumer 14 may also be required to input personal information and/or accept any terms and conditions that are required for participating in network 10, 10′.

A system according to the present invention may also include a billing element. The billing element may administer periodic billing of consumers on behalf of the vendor, as well as consumers' accounts receivable. The billing element may store information about each reward partner or reward that was selected (e.g., affirmatively preselected, selected by default, etc.) by a particular consumer. Upon determining that a consumer's bill has been paid in full and on time, the billing element may trigger the granting of one or more rewards, including one or more rewards from one or more preselected reward partners, or one or more preselected rewards, to that consumer.

As a consumer 14 earns rewards 26, he or she may redeem rewards through the system by selecting any rewards that are to be redeemed. In some embodiments, reward 26 redemption may be effected electronically, such as by crediting a consumer 14's account with a particular reward partner 16 and verified by way of a statement from that reward partner 16 (e.g., a line item on bill, etc.). In other embodiments, a consumer 14 may redeem a reward 26 by printing a reward certificate or coupon, which may then be presented to the reward partner 16.

In addition to a billing element, a system of the present invention may include a tracking element. The tracking element may be configured to track a consumer's use of rewards; monitor the purchases of individual consumers or a group of consumers belonging to a particular network, the accumulation of rewards by individual consumers or a group of consumers belonging to a particular network; and/or the buying habits of individual consumers belonging to a particular network or a group of consumers in the network.

In addition to such monitoring, the tracking element may be configured to analyze the monitored information. The information may be analyzed and evaluated for a variety of purposes, including, without limitation, the identification of goods or services that would likely be desirable to a targeted group of consumers. With such information, additional goods or services may be made available to consumers, as many rewards for enticing the consumers to obtain such goods or services.

The tracking element may also be configured to evaluate the effectiveness of a particular reward partner's advertising efforts within a network that incorporates teachings of the present invention.

Additionally, the tracking element may be configured to present the information that is obtained from monitoring efforts in a way that will be of use or interest to reward partners who participate in a network, as well as potential reward partners and vendors that may have an interest in participating in a network that incorporates teachings of the present invention.

Although the foregoing description contains many specifics, these should not be construed as limiting the scope of the present invention, but merely as providing illustrations of some of the presently preferred embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

What is claimed:

1. A reward network, comprising:
a vendor to which payments are due by a periodic deadline;
a plurality of consumers, each consumer liable for making the payments by the periodic deadline; and
at least one reward partner that makes at least one reward available for granting to each consumer of the plurality only if that consumer makes a payment by the periodic deadline, the at least one reward being configured to increase the consumer's exposure to the reward partner.

2. The reward network of claim 1, wherein the at least one reward is granted to a consumer only upon timely receipt by the vendor of a full payment by or on behalf of the consumer.

3. The reward network of claim 1, wherein the reward partner or the vendor grants the at least one reward to the consumer.

4. The reward network of claim 1, wherein the vendor comprises a landlord and the plurality of consumers comprise tenants.

5. The reward network of claim 3 wherein the payments comprise rent.

6. The reward network of claim 1, wherein the at least one reward comprises a financial reward.

7. The reward network of claim 1, further comprising:
at least one administrator.

8. The reward network of claim 7, wherein the at least one administrator establishes relationships between the vendor and the at least one reward partner.

9. The reward network of claim 7, wherein the at least one reward partner pays the at least one administrator a fee for the ability to participate in the reward network.

10. The reward network of claim 7, wherein the at least one administrator grants the reward directly to the consumer or the at least one administrator provides the reward to the vendor for the vendor to grant to the consumer.

11. A method for encouraging consumers to pay periodic bills on time, comprising providing the consumers with a positive incentive provided by at least one third party reward partner to make timely payments to the vendor.

12. The method of claim 11, wherein providing the financial incentive comprises providing the consumers with coupons for goods or services.

13. The method of claim 12, further comprising enabling a consumer to select one or more third party reward partners whose reward or rewards will be granted by the vendor to the consumer upon the consumer's timely payment of the periodic bill.

14. The method of claim 11, wherein providing the financial incentive comprises providing an increased or cumulative financial incentive for a consumer's faithful payment of periodic bills over a predetermined period of time.

15. A method for administering a reward system for encouraging timely payment of periodic bills, comprising:
establishing a relationship between a vendor and at least one reward partner;
attracting consumers to the vendor's business by advertising the availability of at least one reward from the at least one rewards partner; and
providing consumers that pay their periodic bills to the vendor on time with at least one reward from the at least one reward partner.

16. The method of claim 15, wherein establishing relationships comprises establishing a relationship between at least one vendor and a plurality of reward partners.

17. The method of claim 16, further comprising:
allowing each consumer to select at least one reward partner whose reward or rewards will be granted to that consumer or at least one reward that will be granted to that consumer when the vendor receives payment of that consumer's periodic bill on time.

18. The method of claim 15, wherein establishing the relationship is effected by a fourth party administrator.

19. The method of claim 18, wherein establishing the relationship includes the at least one reward partner's compensating the fourth party administrator.

20. The method of claim 15, further comprising:
monitoring at least one of:
usage of rewards by consumers;
accumulation of rewards by consumers; and
buying habits of individual consumers or a group of consumers; and
analyzing monitored data; and
presenting the monitored data to at least one of a reward partner, a potential reward partner, and a potential vendor.

21. A periodic payment system, comprising:
a billing element accessible by a vendor and configured to:
administer periodic billing of consumers on behalf of the vendor and consumers' accounts receivable by the vendor; and
administer granting of at least one reward from at least one reward partner to a consumer for timely payment of a periodic bill.

22. The periodic payment system of claim 21, wherein the billing element is further configured to:
store at least one selected reward partner or at least one selected reward for each consumer, such that administration of the granting of at least one reward comprises granting at least one reward from at least one selected reward partner or granting at least one selected reward.

23. The periodic payment system of claim 21, further comprising:
a tracking element accessible by the reward partner and configured to:
track a consumer's use of at least one reward.

24. The periodic payment system of claim 21, wherein the tracking element is further configured to:
monitor at least one of:
a consumer's purchases;
accumulation of rewards by one or more consumers; and
buying habits of one or more consumers;
analyze monitored data; and
presenting the monitored data to at least one of a reward partner, a potential reward partner, and a potential vendor.

25. The periodic payment system of claim 24, wherein the tracking element is further configured to:
identify additional goods or services that the consumer may be inclined to purchase based on the consumer's purchases; and
make at least one reward for the additional goods or services available to the consumer.
